(19) United States
(12) Patent Application Publication
(10) Pub. No.: US 2026/0070640 A1
(43) Pub. Date: Mar. 12, 2026

(54) BOAT PROPULSION DEVICE AND BOAT

(71) Applicant: YAMAHA HATSUDOKI KABUSHIKI KAISHA, Iwata-shi (JP)

(72) Inventor: Takafumi TANIGUCHI, Shizuoka (JP)

(21) Appl. No.: 19/324,331

(22) Filed: Sep. 10, 2025

(30) Foreign Application Priority Data
Sep. 11, 2024 (JP) 2024-157182

(51) Int. Cl. B63H 21/30

(52) U.S. Cl. CPC B63H 21/30

(57) ABSTRACT

A boat propulsion device includes an engine, a propeller shaft, a transmission, a cover, a shoe pin, a shoe, and an elastic member. The transmission includes a drive gear and a driven gear meshing with the drive gear. The cover is configured to cover the propeller shaft. The shoe pin is between the propeller shaft and the cover and is rotatable around the propeller shaft. The shoe is attached to the shoe pin and is rotatable around the shoe pin. The shoe includes a first portion on a first side and a second portion on a second side of a direction intersecting the radial direction of the propeller shaft with respect to the shoe pin. The center of gravity of the shoe is in the first portion. The elastic member is configured to exert a force to cause the second portion and the cover to contact each other.

### CROSS REFERENCE TO RELATED APPLICATIONS

This application claims the benefit of priority to Japanese Patent Application No. 2024-157182 filed on Sep. 11, 2024. The entire contents of this application are hereby incorporated herein by reference.

### BACKGROUND OF THE INVENTION

### 1. Field of the Invention

The technologies disclosed in this specification relate to boat propulsion devices and boats.

### 2. Description of the Related Art

A known boat propulsion device includes an engine, an output shaft, an input pinion that rotates by the driving force of the engine, a forward gear and a reverse gear that mesh with the input pinion, and an actuator. The actuator reduces rattling noise by braking the forward gear or backward gear. The actuator is driven electrically, hydraulically, or pneumatically (see, e.g., JP 4499876 B).

There is a room for improvement in reducing the rattling noise of boat propulsion devices.

### SUMMARY OF THE INVENTION

Example embodiments of the present invention disclose technologies that are able to solve the above-described problem, and can be implemented in the following aspects, for example.

A boat propulsion device according an example embodiment of the present invention includes an engine, a propeller shaft, a transmission, a cover, a shoe pin, a shoe, and an elastic member. The transmission is configured to transmit a propulsion force of the engine to the propeller shaft. The transmission includes a drive gear to rotate by the driving force of the engine and a driven gear to mesh with the drive gear. The cover is configured to cover an outer circumference of the propeller shaft. The shoe pin is between the propeller shaft and the cover and rotates around the propeller shaft along with the rotation of the propeller shaft. The shoe is attached to the shoe pin and rotates around the shoe pin. The shoe includes a first portion located on a first side of a direction that intersects a radial direction of the propeller shaft with respect to the shoe pin, and a second portion located on a second side of the direction that intersects the radial direction of the propeller shaft with respect to the shoe pin. The center of gravity of the shoe is located on the first portion. The elastic member is configured to exert a force that causes the second portion and the cover to come into contact with each other.

The boat propulsion device described above is able to reduce rattling noise by applying friction to the propeller shaft through the action of the elastic member and reduce the friction applied to the propeller shaft as the rotation speed of the propeller shaft increases.

A boat propulsion device according to another example embodiment of the present invention includes an engine, a shaft, a transmission, a cover, a shoe pin, a shoe, and an elastic member. The transmission is configured to transmit a driving force of the engine to the shaft. The transmission includes a drive gear to rotate by the driving force of the engine and a driven gear to mesh with the drive gear. The cover is configured to cover an outer circumference of the shaft. The shoe pin is between the shaft and the cover and rotates around the shaft along with the rotation of the propeller shaft. The shoe is attached to the shoe pin and rotates around the shoe pin. The shoe includes a first portion located on a first side of a direction that intersects a radial direction of the shaft with respect to the shoe pin, and a second portion located on a second side of the direction that intersects the radial direction of the shaft with respect to the shoe pin. The center of gravity of the shoe is located on the first portion. The elastic member is configured to exert a force to cause the second portion and the cover to come into contact with each other.

The boat propulsion device described above is able to reduce rattling noise by applying friction to the shaft through the action of the elastic member, and reduce the friction applied to the shaft as the rotation speed of the shaft increases.

The technologies disclosed herein may be implemented in various applications and example embodiments including, e.g., boat propulsion devices or boats provided with boat propulsion devices and boat bodies.

Example embodiments of the boat propulsion devices disclosed herein are able to reduce rattling noise by applying friction to the shaft through the action of the elastic member, and reduce the friction applied to the shaft as the rotation speed of the shaft increases.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating a configuration of a boat.

FIG. 2 is a side view schematically illustrating a configuration of an outboard motor.

FIG. 3 is an explanatory view illustrating a detailed configuration of an area around a propeller shaft.

FIG. 4 is an enlarged view of a portion of FIG. 3.

FIG. 5 is a cross-sectional view of the outboard motor taken along line V-V in FIG. 3.

FIG. 6 is an explanatory view illustrating a detailed configuration of an area around a shoe in a state where a rotation speed of an engine body is relatively low.

FIG. 7 is an explanatory view illustrating a detailed configuration of the area around the shoe in a state where the rotation speed of the engine body is relatively high.

### DETAILED DESCRIPTION OF THE EXAMPLE EMBODIMENTS

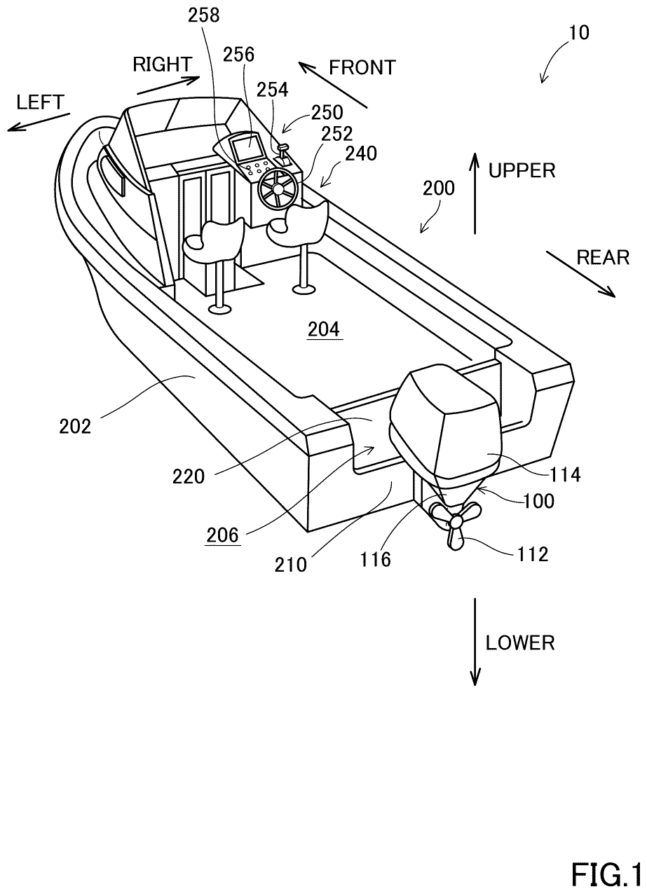

FIG. 1 is a perspective view schematically illustrating a configuration of a boat 10. FIG. 1 and the other figures described below show arrows representing each direction with respect to the position of the boat 10. More specifically, each drawing shows arrows representing the front direction (FRONT), rear direction (REAR), left direction (LEFT), right direction (RIGHT), upper direction (UPPER), and lower direction (LOWER), respectively. The front-rear direction, left-right direction, and upper-lower (vertical) direction are orthogonal to each other. It should be noted that, in this specification, axes, members, and the like, extending in the front-rear direction need not necessarily be parallel to the front-rear direction. Axes and members extending in the front-rear direction include axes and members that are inclined in the range of ±45° to the front-rear direction. Similarly, axes and members extending in the upper-lower direction include axes and members inclined within a range of ±45° to the upper-lower direction, and axes and members extending in the left-right direction include axes and members inclined within a range of ±45° to the left-right direction.

The boat 10 includes a boat body 200 and an outboard motor 100. In this example embodiment, the boat 10 includes only one outboard motor 100, but the boat 10 may include multiple outboard motors 100.

The boat body 200 is the portion of the boat 10 for occupants to ride. The boat body 200 includes a boat main body 202, a pilot seat 240, and a steering device 250. The boat main body 202 includes a living space 204. The pilot seat 240 is located in the living space 204. The steering device 250 is located near the pilot seat 240. The steering device 250 steers the boat. The steering device 250 includes, e.g., a steering wheel 252, a shift/throttle lever 254, a monitor 256, and an input device 258. The boat body 200 also includes a partition wall 220 and a transom 210. The partition wall 220 partitions the rear end of the living space 204. The transom 210 is located at the rear end of the boat body 200. In the front-rear direction, there is a space 206 between the transom 210 and the partition wall 220.

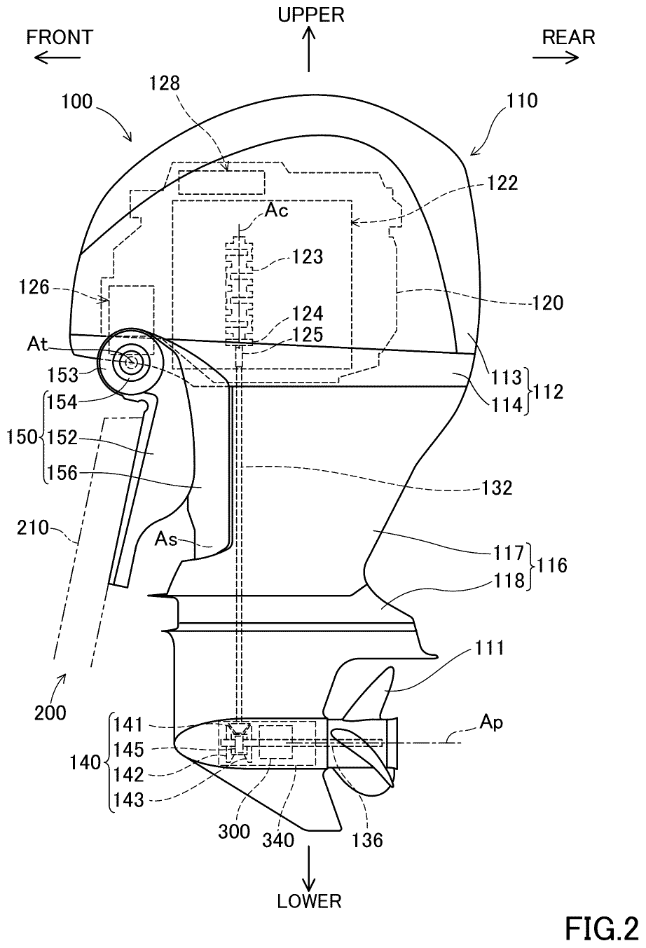

FIG. 2 is a side view schematically illustrating a configuration of an outboard motor 100. The following description refers to the outboard motor 100 in the reference attitude unless otherwise specified. The reference attitude is an attitude in which the rotation axis Ac of the crankshaft 123, which will be described below, extends in the upper-lower direction and the rotation axis Ap of the propeller shaft 136, which will be described below, extends in the front-rear direction. The front-rear direction, the left-right direction, and the upper-lower direction are respectively defined based on the outboard motor 100 in the reference attitude. The outboard motor 100 is an example of a boat propulsion device.

The outboard motor 100 generates thrust to propel the boat 10. The outboard motor 100 is attached to the transom 210 at the rear portion of the boat body 200. The outboard motor 100 includes an outboard motor main body 110 and a suspension device 150.

The outboard motor main body 110 includes an engine assembly 120, a cowl 112, a casing 116, a drive shaft 132, a propeller shaft 136, a propeller 111, a transmission 140, a silencer 300, and a housing 340.

The engine assembly 120 is an assembly of multiple parts, including an engine body 122. The engine assembly 120 includes, in addition to the engine body 122, intake system components 126 (e.g., throttle bodies, superchargers, and the like) and electrical components 128 (e.g., fuse boxes, ECUs, steering CUs, and the like). The engine assembly 120 is located in a relatively upper portion of the outboard motor 100.

The engine body 122 is a prime mover that generates power. The engine body 122 may be, e.g., an internal combustion engine. The engine body 122 includes a crankshaft 123 that converts the reciprocating motion of a piston, which is not shown in the figure, into rotational motion. The crankshaft 123 is arranged in an attitude in which its rotation axis Ac extends in an upper-lower direction. The crankshaft 123 includes a journal 124 and a spline 125. The journal 124 supports the crankshaft 123 in the bearing portion of the crankcase, which is not shown in the figure. The spline 125 includes multiple vertical grooves to connect with the drive shaft 132.

The cowl 112 is a housing body arranged in the upper portion of the outboard motor main body 110. The cowl 112 includes an upper cowl 113 and a lower cowl 114. The upper cowl 113 corresponds to the upper portion of the cowl 112. The lower cowl 114 corresponds to the lower portion of the cowl 112. The upper cowl 113 is removably attached to the lower cowl 114. The cowl 112 accommodates at least a portion of the engine assembly 120.

The casing 116 is a housing disposed in the lower portion of the outboard motor main body 110. The casing 116 is located below the cowl 112. The casing 116 includes an upper case 117 and a lower case 118. The upper case 117 corresponds to the upper portion of the casing 116. The lower case 118 corresponds to the lower portion of the casing 116.

The drive shaft 132 is a rod-shaped member that extends in the upper-lower direction. The upper end portion of the drive shaft 132 is connected to the spline 125 of the engine body 122. The drive shaft 132 extends downward from the connecting portion with the spline 125. The drive shaft 132 rotates together with the crankshaft 123 by the driving force of the engine body 122. At least a portion of the drive shaft 132 is accommodated in the casing 116.

The propeller shaft 136 is a rod-shaped member. The propeller shaft 136 is arranged in an attitude in which its rotation axis Ap extends in the front-rear direction at a relatively lower portion of the outboard motor main body 110. The front end portion of the propeller shaft 136 is accommodated in the lower case 118. The rear end portion of the propeller shaft 136 protrudes rearward from the lower case 118. The propeller shaft 136 is an example of a shaft.

The propeller 111 is a rotating member including multiple blades. The propeller 111 is attached to the rear end portion of the propeller shaft 136. The propeller 111 rotates together with the propeller shaft 136. The propeller 111 rotates to generate thrust for the boat 10.

The transmission 140 transmits the driving force of the engine body 122 to the propeller shaft 136. The transmission 140 includes a first gear 141, a second gear 142, a third gear 143, and a dog clutch 145. The first gear 141 is an example of a drive gear. The second gear 142 and the third gear 143 are examples of driven gears.

The first gear 141 is connected to the lower end portion of the drive shaft 132. The first gear 141 rotates together with the drive shaft 132 by the driving force of the engine body 122. The rotation axis of the first gear 141 is parallel to the rotation axis Ac of the crankshaft 123. That is, the rotation axis of the first gear 141 is parallel to the upper-lower direction.

The second gear 142 and the third gear 143 are tubular gears that surround the front end portion of the propeller shaft 136. The rotation axes of the second gear 142 and the third gear 143 are parallel to the propeller shaft 136 rotation axis Ap.

That is, the rotation axes of the second gear 142 and the third gear 143 are parallel to the horizontal direction and perpendicular to the rotation axis of the first gear 141. The second gear 142 and the third gear 143 are each meshed with the first gear 141. This allows the driving force of the engine body 122 to be transmitted to the second gear 142 and the third gear 143 via the first gear 141.

The dog clutch 145 is arranged between the second gear 142 and the third gear 143 in the front-rear direction. The dog clutch 145 is tubular and surrounds the front end portion of the propeller shaft 136. The dog clutch 145 is connected to the propeller shaft 136, e.g., by a spline. The dog clutch 145 rotates together with the propeller shaft 136.

The dog clutch 145 is movable in the front-rear direction. More specifically, the dog clutch 145 is movable between a first connected position connecting with the second gear 142, a second connected position connecting with the third gear 143, and a disconnected position away from the second gear 142 and the third gear 143. When the dog clutch 145 is in the first connected position, the rotation of the second gear 142 is transmitted to the dog clutch 145, and the rotation of the dog clutch 145 is transmitted to the propeller shaft 136. As a result, the propeller 111 rotates in the direction that moves the boat 10 forward. When the dog clutch 145 is in the second connected position, the rotation of the third gear 143 is transmitted to the dog clutch 145, and the rotation of the dog clutch 145 is transmitted to the propeller shaft 136. As a result, the propeller 111 rotates in the direction that moves the boat 10 backward. When the dog clutch 145 is in the disconnected position, the rotation of the first gear 141 and second gear 142 is not transmitted to the dog clutch 145. As a result, the propeller 111 does not receive the driving force of the engine body 122. That is, when the dog clutch 145 is in the disconnected position, the outboard motor 100 is in a neutral state.

The silencer 300 and the housing 340 are located in relatively lower portion of the outboard motor 100. The silencer 300 and housing 340 are accommodated in the lower case 118.

Details of the silencer 300 and the housing 340 are described below.

The suspension device 150 connects the outboard motor main body 110 to the boat body 200. The suspension device 150 includes a pair of left and right clamp brackets 152, a tilt shaft 154, and a swivel bracket 156.

The pair of left and right clamp brackets 152 are disposed behind the boat body 200 in a state separated from each other in the left-right direction and are fixed to the transom 210 of the boat body 200 by using, e.g., bolts. Each clamp bracket 152 has a tubular supporting portion 153 provided with a through-hole extending in the left-right direction.

The tilt shaft 154 is a rod-shaped member and is rotatably supported within the through-hole in the supporting portion 153 of the clamp bracket 152. The tilt axis At, which is the centerline of the tilt shaft 154, corresponds to a horizontal (left-right) axis of the tilting action of the outboard motor 100.

The swivel bracket 156 is sandwiched between the pair of clamp brackets 152 and is supported by the supporting portion 153 of the clamp brackets 152 via the tilt shaft 154 so as to be rotatable around the tilt axis At. The swivel bracket 156 is driven to rotate about the tilt axis At with respect to the clamp bracket 152 by a tilt device (not shown) that includes an actuator, such as a hydraulic cylinder, for example.

When the swivel bracket 156 rotates about the tilt axis At with respect to the clamp bracket 152, the outboard motor main body 110 supported by the swivel bracket 156 also rotates about the tilt axis At. This achieves the tilting action of rotating the outboard motor main body 110 in the upper-lower direction with respect to the boat body 200. By this tilting action, the outboard motor 100 can change the angle of the outboard motor main body 110 around the tilt axis At in the range from the tilt-down state in which the propeller 111 is disposed under the water (the state in which the outboard motor 100 is in the reference attitude) to the tilt-up state in which the propeller 111 is disposed above the water surface. Trimming action to adjust the attitude of the boat 10 during travel can also be performed by adjusting the angle around the tilt axis At of the outboard motor main body 110.

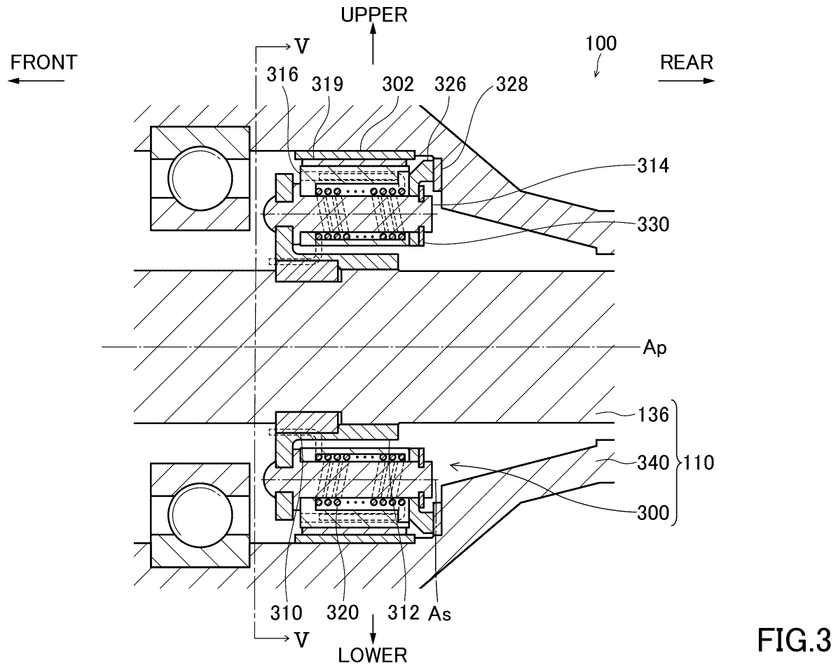

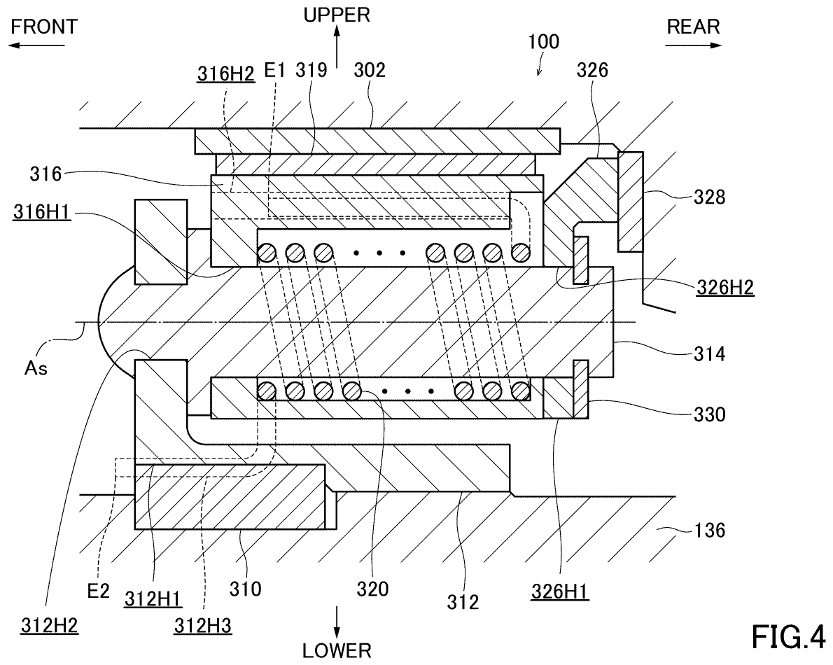

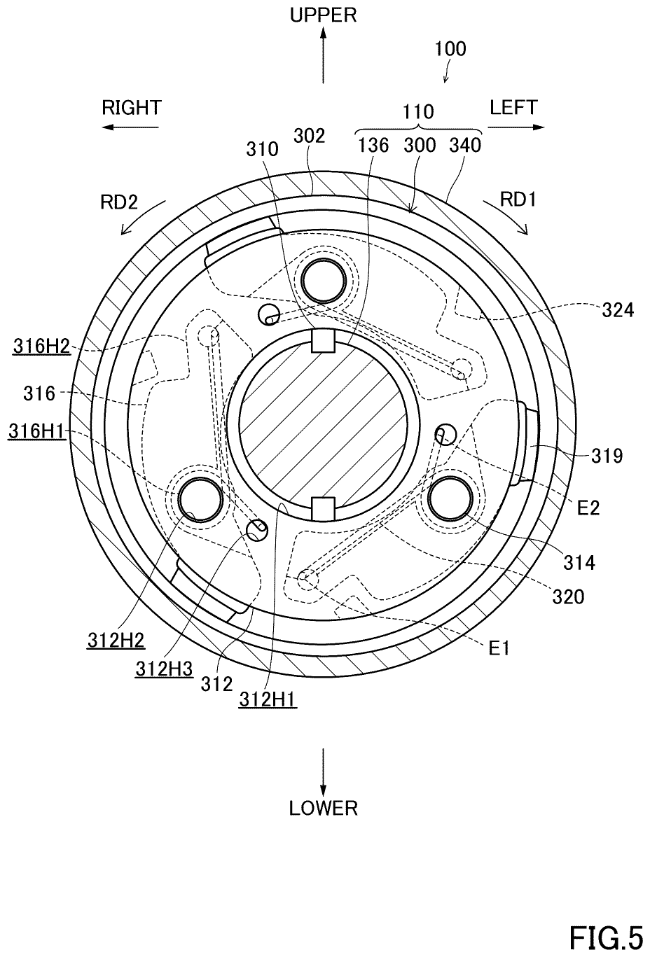

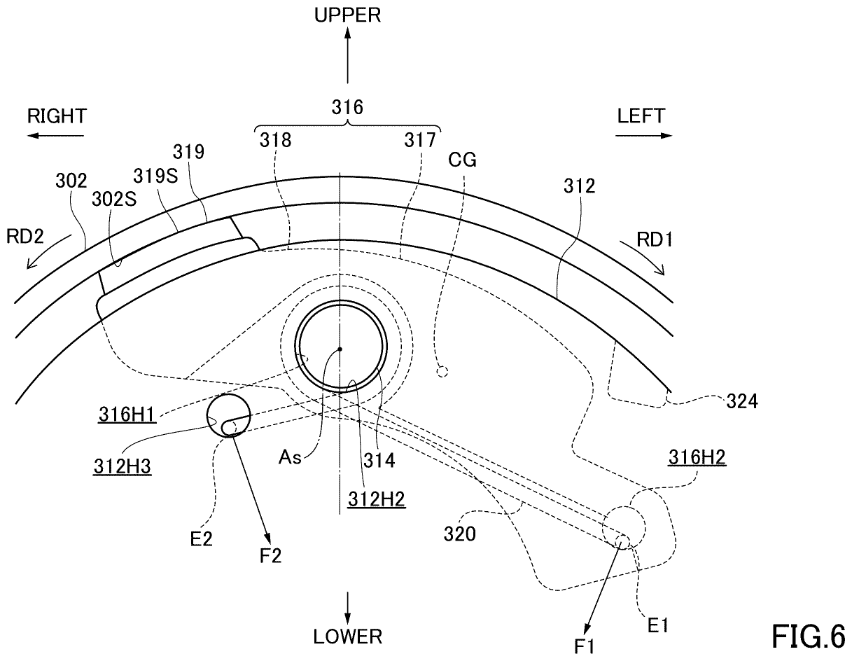

FIG. 3 is an explanatory view illustrating a detailed configuration of the area around the propeller shaft 136. FIG. 4 is an enlarged view of a portion of FIG. 3. FIG. 5 is a cross-sectional view of the outboard motor 100 taken along line V-V in FIG. 3. FIG. 6 is an explanatory view illustrating a detailed configuration of the area around the shoe 316 in a state where the rotation speed of the engine body 122 is relatively low.

FIGS. 3 and 4 show a cross-section of the outboard motor 100 perpendicular to the left-right direction. FIGS. 5 and 6 show cross-sections of the outboard motor 100 perpendicular to the front-rear direction. In FIGS. 5 and 6, the first rotating direction RD1 and the second rotating direction RD2 are shown as the rotating directions of the propeller shaft 136. The first rotating direction RD1 is the clockwise direction when viewed from the front, and the second rotating direction RD2 is the counterclockwise direction when viewed from the front.

The silencer 300 is an assembly of components arranged around the propeller shaft 136. As will be described below, the silencer 300 reduces the rattling noise that occurs between the first gear 141 and the second gear 142, and the rattling noise that occurs between the first gear 141 and the third gear 143, by applying friction to the propeller shaft 136. The housing 340 accommodates the silencer 300. In this example embodiment, oil is stored inside the housing 340. The housing 340 is an example of a case.

The silencer 300 includes a cover 302, a key 310, a base 312, a shoe pin 314, a shoe 316, a torsion spring 320, a stopper 324, a shoe plate 326, a thrust washer 328, and a clip 330.

The cover 302 is a tubular member that extends in the front-rear direction. The cover 302 is configured to cover the outer circumference of the propeller shaft 136. The shape of the inner circumferential surface 302S of the cover 302 when viewed in the axial direction of the propeller shaft 136 is circular.

The key 310 is a prismatic member that extends in the front-rear direction. The key 310 is disposed between the propeller shaft 136 and the cover 302 in the radial direction of the propeller shaft 136. The key 310 is connected to a portion of the surface of the propeller shaft 136 that faces the outer side in the radial direction of the propeller shaft 136. The key 310 rotates together with the propeller shaft 136. In this example embodiment, the outboard motor 100 includes two keys 310 arranged at positions that differ from each other in the rotating direction of the propeller shaft 136.

The base 312 is a member including a hole 312H1 in the center. The base 312 is arranged between the propeller shaft 136 and the cover 302 in the radial direction of the propeller shaft 136. The propeller shaft 136 extends through the hole 312H1 of the base 312. The base 312 surrounds the propeller shaft 136. A portion of the surface of the base 312 facing the hole 312H1 is connected to the key 310. The base 312 rotates around the propeller shaft 136 together with the key 310 along with the rotation of the propeller shaft 136. In addition, the base 312 is provided with holes 312H2 and 312H3 between the hole 312H1 in the radial direction of the propeller shaft 136 and the outer edge of the base 312. In this example embodiment, the base 312 includes three holes 312H2 that are located at different positions in the rotating direction of the propeller shaft 136, and three holes 312H3 that are located at different positions in the rotating direction of the propeller shaft 136.

The shoe pin 314 is a rod-shaped member that extends in the front-rear direction. In this example embodiment, the outboard motor 100 is provided with three shoe pins 314 arranged at positions that differ from each other in the rotating direction of the propeller shaft 136. The shoe pins 314 are disposed between the propeller shaft 136 and the cover 302. The front end portion of the shoe pin 314 is inserted into the hole 312H2 of the base 312. The shoe pin 314 is connected to the surface of the base 312 facing the hole 312H2. The shoe pin 314 rotates around the propeller shaft 136 together with the base 312 along with the rotation of the propeller shaft 136.

The shoe 316 is a member that extends in the rotating direction of the propeller shaft 136 when viewed in the front-rear direction. The shoe 316 is disposed between the propeller shaft 136 and the cover 302 in the radial direction of the propeller shaft 136. In this example embodiment, the outboard motor 100 includes three shoes 316 disposed at positions that are different from each other in the rotating direction of the propeller shaft 136. The three shoes 316 are arranged at equal or substantially equal intervals in the rotating direction of the propeller shaft 136.

The shoe 316 is provided with a hole 316H1 near the center of the rotating direction of the propeller shaft 136 and a hole 316H2 at the end portion on the first rotating direction RD1 side in the rotating direction of the propeller shaft 136 with respect to the hole 316H1. The hole 316H1 of the shoe 316 is inserted with a shoe pin 314. The shoe 316 is attached to the shoe pin 314. The shoe 316 rotates around the propeller shaft 136 together with the shoe pin 314 along with the rotation of the propeller shaft 136. In addition, the shoe 316 rotates around the shoe pin 314. The rotation axis As of the shoe 316 around the shoe pin 314 coincides with the center axis of the shoe pin 314. The rotation axis As of the shoe 316 is parallel to the rotation axis Ap of the propeller shaft 136.

The configuration of the shoe 316 is explained in detail with reference to FIG. 6. The shoe 316 includes a first portion 317 and a second portion 318. The first portion 317 is located on one side of the direction (circumferential direction) that intersects the radial direction of the propeller shaft 136 with respect to the center axis of the shoe pin 314 when the outboard motor 100 is stopped. More specifically, the first portion 317 is located on the first rotating direction RD1 side with respect to the center axis of the shoe pin 314 when the outboard motor 100 is stopped. The second portion 318 is located on the other side of the direction (circumferential direction) that intersects the radial direction of the propeller shaft 136 with respect to the center axis of the shoe pin 314 when the outboard motor 100 is stopped. More specifically, the second portion 318 is located on the second rotating direction RD2 side with respect to the center axis of the shoe pin 314 when the outboard motor 100 is stopped. The shoe 316 is disposed at a position where the second portion 318 can contact the cover 302 by rotating the shoe 316 around the shoe pin 314 in the radial direction of the propeller shaft 136.

The center of gravity CG of the shoe 316 is located in the first portion 317. In this example embodiment, the shoe 316 includes a first metal and a second metal having a specific gravity lower than that of the first metal. The first metal may be, e.g., iron, and the second metal may be, e.g., aluminum. The first metal is contained in the first portion 317 in greater quantity than in the second portion 318. Thus, in this example embodiment, the center of gravity CG of the shoe 316 is located in the first portion 317 because the first metal, which has a relatively high specific gravity, is present in the first portion 317 in greater quantity than in the second portion 318.

The second portion 318 of the shoe 316 is provided with a friction material 319. The friction material 319 is provided on the surface of the second portion 318 that faces the outer side in the radial direction of the propeller shaft 136.

The friction material 319 is provided at a portion of the second portion 318 that contacts the cover 302. That is, the outer circumferential surface 319S of the friction material 319 is the contact surface with the cover 302. The shape of the outer circumferential surface 319S of the friction material 319 when viewed in the axial direction of the propeller shaft 136 is arcuate.

The torsion spring 320 is wound around the shoe pin 314. The torsion spring 320 is coil-shaped. The center axis of the torsion spring 320 coincides with the center axis of the shoe pin 314 and the rotation axis As. The first end E1 of the torsion spring 320 is inserted into the hole 316H2 of the shoe 316. The first end E1 of the torsion spring 320 is connected to the first portion 317 of the shoe 316. The second end E2 of the torsion spring 320 is inserted into the hole 312H3. The second end E2 of the torsion spring 320 is connected to the base 312. Thus, the second end E2 of the torsion spring 320 is connected to the other portion that rotates around the propeller shaft 136 together with the shoe pin 314 of the outboard motor 100. The torsion spring 320 is an example of an elastic member.

The stopper 324 is attached to the base 312. The base 312 is disposed between the first portion 317 of the shoe 316 and the cover 302 in the radial direction of the propeller shaft 136.

The shoe plate 326 includes a hole 326H1 in the center. The hole 326H1 of the shoe plate 326 surrounds the propeller shaft 136. The shoe plate 326 is provided with a hole 326H2 between the hole 326H1 and the outer edge of the shoe plate 326. In this example embodiment, the shoe plate 326 is provided with three holes 326H2 at equal or substantially equal intervals in the rotating direction of the propeller shaft 136. The rear end portion of the shoe pin 314 is inserted into the hole 326H2 of the shoe plate 326. The surface of the shoe plate 326 facing the hole 326H2 is connected to the shoe pin 314.

The thrust washer 328 is disposed between the shoe plate 326 and the housing 340 in the front-rear direction. The thrust washer 328 contacts the shoe plate 326. Since the shoe plate 326 contacts the thrust washer 328, friction is reduced when it rotates along with the rotation of the propeller shaft 136.

The clip 330 is disposed rearwardly of the shoe plate 326. The clip 330 is in contact with the shoe pin 314 and the shoe plate 326, respectively, and fixes the shoe pin 314 to the shoe plate 326.

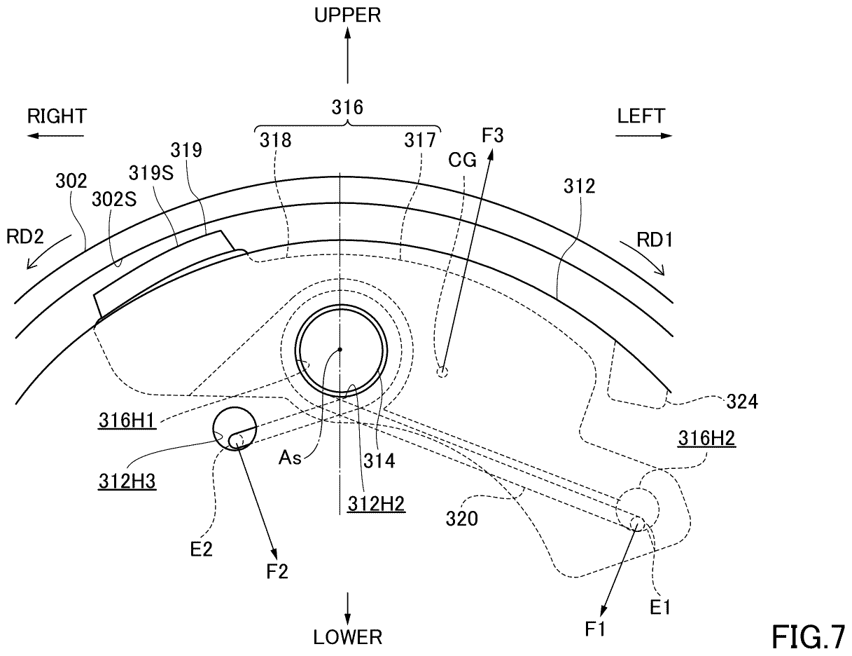

FIG. 7 is an explanatory view illustrating a detailed configuration of the area around the shoe 316 in a state where the rotation speed of the engine body 122 is relatively high.

The action of the silencer 300 will now be explained in detail with reference to FIGS. 6 and 7.

First, the action of the silencer 300 when the rotation speed of the engine body 122 is relatively low will be explained with reference to FIG. 6. An elastic force is acting on the torsion spring 320 to bring the first end E1 and the second end E2 closer together. More specifically, an elastic force F1 in a clockwise direction with respect to the center axis (i.e., rotation axis As) of the torsion spring 320 acts on the first end E1 of the torsion spring 320. On the other hand, an elastic force F2 in a counterclockwise direction with respect to the center axis of the torsion spring 320 acts on the second end E2 of the torsion spring 320.

As described above, the second end E2 of the torsion spring 320 is connected to the hole 312H3 of the base 312, and the first end E1 of the torsion spring 320 is connected to the hole 316H2 of the shoe 316. Therefore, the torsion spring 320 generates a moment that rotates the shoe 316 clockwise around the center axis of the shoe pin 314 by the elastic force F1 acting on the first end E1. Thus, the torsion spring 320 exerts a force that causes the second portion 318 of the shoe 316 and the cover 302 to come into contact with each other. Thus, for example, when the rotation speed of the engine body 122 is relatively low, when the engine body 122 is not rotating, or when the rotation of the engine body 122 is not transmitted to the propeller shaft 136 (i.e., in the neutral state), the friction material 319 of the second portion 318 contacts the cover 302. The shoe 316 exerts friction on the propeller shaft 136 by pressing the second portion 318 against the cover 302.

The outboard motor 100 is likely to generate rattling noise when the rotation speed of the engine body 122 is relatively low. Specifically, e.g., when the rotation speed of the first gear 141 changes due to a change in the rotation speed of the engine body 122, the rotation speed of the second gear 142 and the third gear 143 cannot follow the rotation speed of the first gear 141, which causes the tooth surfaces to contact between the first gear 141 and the second gear 142 and between the first gear 141 and the third gear 143, causing a rattling noise. In an example embodiment of the outboard motor 100, by applying friction to the propeller shaft 136 when the rotation speed of the engine body 122 is relatively low, the rotation speed of the second gear 142 and the third gear 143 becomes easier to follow the rotation speed of the first gear 141. This reduces the rattling noise that occurs between the first gear 141 and the second gear 142, and the rattling noise that occurs between the first gear 141 and the third gear 143.

Next, the action of the silencer 300 when the rotation speed of the engine body 122 is relatively high will be explained with reference to FIG. 7. As in the state where the rotation speed of the engine body 122 is relatively low, the elastic force F1 in a clockwise direction with respect to the center axis of the torsion spring 320 acts on the first end E1 of the torsion spring 320, and the elastic force F2 in a counterclockwise direction with respect to the center axis of the torsion spring 320 acts on the second end E2 of the torsion spring 320. Therefore, when the rotation speed of the engine body 122 is relatively high, the torsion spring 320 also generates a moment that rotates the shoe 316 clockwise around the center axis of the shoe pin 314 by the elastic force F1 acting on the first end E1.

As described above, the shoe 316 rotates around the propeller shaft 136 together with the shoe pin 314 along with the rotation of the propeller shaft 136. Therefore, the shoe 316 is subjected to the centrifugal force F3 generated by the rotation of the propeller shaft 136. The centrifugal force F3 does not mean the centrifugal force to which only the first portion 317 of the shoe 316 is subjected, but the centrifugal force to which the entire shoe 316, including the second portion 318, is subjected. Also, as mentioned above, the shoe 316 rotates around the shoe pin 314. The center of gravity CG of the shoe 316 is located in the first portion 317. Therefore, when the shoe 316 is subjected to the centrifugal force F3 generated by the rotation of the propeller shaft 136, a moment is generated that rotates the shoe 316 counterclockwise around the center axis of the shoe pin 314. If the moment generated by the centrifugal force F3, which rotates the shoe 316 counterclockwise around the center axis of the shoe pin 314, exceeds the moment generated by the elastic force F1, which rotates the shoe 316 clockwise around the center axis of the shoe pin 314, the first portion 317 will be displaced outwardly in the radial direction of the propeller shaft 136. Thus, when the rotation speed of the propeller shaft 136 exceeds a certain value, the friction material 319 of the second portion 318 moves away from the cover 302. When the friction material 319 moves away from the cover 302, the entire outer circumferential surface 319S moves away from the cover 302 at the same time.

The outboard motor 100 is less likely to generate rattling noise when the rotation speed of the engine body 122 is relatively high. In the outboard motor 100 of this example embodiment, when the rotation speed of the propeller shaft 136 exceeds a certain value, the friction applied to the propeller shaft 136 is reduced, thus reducing the occurrence of rattling noise and reducing the friction applied to the propeller shaft 136 along with the increase in the rotation speed of the propeller shaft 136.

The rotation speed of the engine body 122 to cause the second portion 318 of the shoe 316 to move away from the cover 302 can be set to any value by adjusting the mass of the shoe 316, the position of the center of gravity CG of the shoe 316, and the like. In this example embodiment, the second portion 318 of the shoe 316 comes into contact with the cover 302 when the rotation speed of the engine body 122 is lower than the trolling rotation speed, and moves away from the cover 302 when the rotation speed of the engine body 122 is higher than the trolling rotation speed.

In addition, the stopper 324 is arranged between the first portion 317 of the shoe 316 and the cover 302. Therefore, in this example embodiment, when the rotation speed of the engine body 122 is higher than the trolling rotation speed, none of the elements of the shoe 316 come into contact with the cover 302.

The techniques disclosed herein are not limited to the above-described example embodiments and may be modified in various forms without departing from the gist of the present invention, including the following modifications.

The configuration of the boat 10 and the outboard motor 100 in the above-mentioned example embodiments is just one example, and can be modified in various ways. For example, in the above example embodiments, the boat propulsion device is exemplified by the outboard motor 100, the boat propulsion device may also be an inboard motor or a jet propeller.

In the above example embodiments, the outboard motor 100 includes only the engine body 122 as its drive source, but the boat propulsion device may also be a hybrid type that includes a motor in addition to the engine.

In the above example embodiments, the rotation axis As of the shoe 316 is parallel to the rotation axis Ap of the propeller shaft 136, but the rotation axis of the shoe does not necessarily have to be parallel to the rotation axis of the propeller shaft.

In the above example embodiments, the friction material 319 is provided in the second portion 318, but it is not necessarily required to provide the friction material.

In the above example embodiments, the shape of the inner circumferential surface 302S of the cover 302 when viewed in the axial direction of the propeller shaft 136 is circular, but the shape of the inner circumferential surface of the cover when viewed in the axial direction of the propeller shaft may be any shape. In the above example embodiments, the shape of the outer circumferential surface 319S of the friction material 319 when viewed in the axial direction of the propeller shaft 136 is arcuate, but the shape of the outer circumferential surface of the friction material when viewed in the axial direction of the propeller shaft may be any shape.

In the above example embodiments, the entire outer circumferential surface 319S moves away from the cover 302 at the same time, but the contact surface of the friction material with the cover may gradually move away from the cover 302 as the rotation speed of the engine body 122 increases.

In the above example embodiments, the shoe 316 contains the first metal and the second metal, but the shoe does not necessarily have to contain the first metal and the second metal. For example, the center of gravity of the shoe may be adjusted by changing the shape of the shoe, e.g., or by changing the density distribution of the shoe in the rotating direction of the propeller shaft.

In the above example embodiments, the outboard motor 100 is provided with three shoes 316, but the boat propulsion device only needs to be provided with at least one shoe.

In the above example embodiments, the outboard motor 100 is provided with the torsion spring 320 as an elastic member, but the boat propulsion device may be provided with an elastic member other than the torsion spring.

In the above example embodiments, oil is stored inside the housing 340, but the inside of the case may not store oil.

In the above example embodiments, the shaft is exemplified by the propeller shaft 136, but the shaft may be a shaft other than a propeller shaft.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A boat propulsion device comprising:
an engine;
a propeller shaft;
a transmission to transmit a propulsion force of the engine to the propeller shaft and including:
a drive gear to rotate by the propulsion force of the engine; and
a driven gear to mesh with the drive gear;
a cover configured to cover an outer circumference of the propeller shaft;
a shoe pin between the propeller shaft and the cover to rotate around the propeller shaft along with the rotation of the propeller shaft;
a shoe attached to the shoe pin to rotate around the shoe pin and including:
a first portion located on a first side of a direction that intersects a radial direction of the propeller shaft with respect to the shoe pin; and
a second portion located on a second side of the direction that intersects the radial direction of the propeller shaft with respect to the shoe pin; wherein
a center of gravity of the shoe is located in the first portion; and
an elastic member is configured to exert a force to cause the second portion and the cover to come into contact with each other.

2. The boat propulsion device according to claim 1, wherein the second portion is configured to move away from the cover by the shoe being subjected to the centrifugal force generated by the rotation of the propeller shaft.

3. The boat propulsion device according to claim 2, wherein the second portion is configured to move away from the cover when the rotation speed of the engine is greater than a trolling rotation speed.

4. The boat propulsion device according to claim 1, wherein a rotation axis of the shoe is parallel to a rotation axis of the propeller shaft.

5. The boat propulsion device according to claim 1, wherein the second portion includes a friction material at a portion that contacts the cover.

6. The boat propulsion device according to claim 5, wherein
an inner circumferential surface of the cover when viewed in an axial direction of the propeller shaft is circular; and
an outer circumferential surface of the friction material when viewed in the direction of the propeller shaft is arcuate.

7. The boat propulsion device according to claim 6, wherein
the friction material includes a contact surface configured to contact the cover; and
in response to the friction material moving away from the cover due to the shoe rotating around the shoe pin, an entirety of the contact surface moves away from the cover at a same time.

8. The boat propulsion device according to claim 1, wherein
the shoe includes a first metal and a second metal having a lower specific gravity than the first metal; and
the first metal is in the first portion in a greater quantity than in the second portion.

9. The boat propulsion device according to claim 8, wherein the first metal includes iron and the second metal includes aluminum.

10. The boat propulsion device according to claim 1, wherein the shoe includes a plurality of shoes.

11. The boat propulsion device according to claim 10, wherein the plurality of shoes are arranged at equal or substantially intervals in a rotating direction of the propeller shaft.

12. The boat propulsion device according to claim 1, wherein the elastic member includes a torsion spring.

13. The boat propulsion device according to claim 12, wherein
the torsion spring is wound around the shoe pin;
a first end of the torsion spring is connected to the shoe; and
a second end of the torsion spring is connected to a portion that is rotatable around the propeller shaft along with the shoe pin in the boat propulsion device.

14. The boat propulsion device according to claim 13, wherein the first end of the torsion spring is connected to the first portion.

15. The boat propulsion device according to claim 1, further comprising:
a drive shaft to rotate by the propulsion force of the engine; wherein
the drive gear to rotate together with the drive shaft; and
the transmission further includes a dog clutch rotatable together with the propeller shaft and movable between a connected position that connects with the driven gear and a disconnected position spaced away from the driven gear.

16. The boat propulsion device according to claim 1, further comprising:
a shoe plate connected with the shoe pin.

17. The boat propulsion device according to claim 1, further comprising:
a stopper between the first portion and the cover.

18. The boat propulsion device according to claim 1, further comprising:
a case to accommodate the cover, the shoe pin, the shoe, and the elastic member; wherein
oil is stored inside the case.

19. A boat comprising:
a boat body; and
the boat propulsion device according to claim 1 attached to a rear portion of the boat body.

20. A boat propulsion device comprising:
an engine;
a shaft;
a transmission to transmit a propulsion force of the engine to the shaft and including:
a drive gear to rotate by the propulsion force of the engine; and
a driven gear to mesh with the drive gear;
a cover configured to cover an outer circumference of the shaft;
a shoe pin between the shaft and the cover to rotate around the shaft along with rotation of the shaft;
a shoe attached to the shoe pin to rotate around the shoe pin and including:
a first portion located on a first side of a direction that intersects a radial direction of the shaft with respect to the pin shoe; and
a second portion located on a second of the direction that intersects the radial direction of the shaft with respect to the pin shoe; wherein
a center of gravity of the shoe is located in the first portion; and
an elastic member is configured to exert a force to cause the second portion and the cover to come into contact with each other.
